(19) United States
(12) Patent Application Publication
(10) Pub. No.: US 2003/0000487 A1
(43) Pub. Date: Jan. 2, 2003

(54) Device for cooling an internal combustion engine

(76) Inventor: Manfred Schmitt, Heppenheim (DE)

Correspondence Address: Striker Striker Stenby, 103 East Neck Road, Huntington, NY, 11743, US

(21) Appl. No.: 10/088,145

(22) PCT Filed: Jun. 28, 2001
(86) PCT No.: PCT/DE01/02329

(30) Foreign Application Priority Data
Jul. 1, 2001 (DE) 100 32 184.4

(51) Int. Cl. F02F 1/10

(52) U.S. Cl. 123/41.72

(57) ABSTRACT

The invention relates to an apparatus (10) for cooling an internal combustion engine (11), preferably a 4-cylinder in-line engine, having coolant connections (13, 13′, 14, 14′; 17, 17′-24, 24′) to a cooling loop, the coolant connections being connected to at least one cooling jacket region (12′, 12″, 12′″) of the engine (11). The invention provides that as the coolant connections, a group of inflow lines (17-24) and outflow lines (17′-24′), paired with one another, is provided, and each pair of inflow and outflow lines, because of its respective flow direction, defines a flow path, and each cylinder (15, 15′, 15″, 15′″) is assigned at least one flow path supplying it. The flow directions of these flow paths extend transversely to the longitudinal direction of the crankshaft defined by the in-line arrangement of individual cylinders (15, 15, 15″, 15′″). A further group of inflow and outflow lines (13, 13′; 14, 14′) is disposed longitudinally to the longitudinal direction of the crankshaft. Because additionally the inflow and outflow lines disposed transversely thereto each have metering bores, by means of a coolant delivery to each cylinder that is adaptable via these metering bores, a thermal cylinder synchronization for each operating point is attainable.

### PRIOR ART

The invention is based on an apparatus for cooling an internal combustion engine, preferably a 4-cylinder in-line engine, as generically defined by the preamble to the main claim.

From European Patent Disclosure EP 0 038 556, an apparatus of this generic type is already known. In it, a cylinder head and a cylinder block received in the engine each have a cooling jacket region, embodied as a cooling pocket; the cooling pockets disposed separately from one another have coolant connections on the inflow and outflow sides for coupling to the cooling loop, so that the cylinder head and the cylinder block of the engine can be supplied separately from one another with coolant, so that thermal regulation of the cylinder head and the cylinder block separately from one another is accordingly possible. An unsatisfactory aspect of this prior art, however, is that because of the integral cooling of all the cylinders, a targeted cooling of individual cylinders of the engine as a function of the operating point cannot be accomplished.

### ADVANTAGES OF THE INVENTION

The apparatus of the invention as defined by the characteristics of the body of the main claim has the advantage over the prior art that because of the geometric disposition of the inflow and outflow lines and their flow direction relative to the disposition of the cylinders, each individual cylinder is in direct flow contact with a flow path allocated to it, and thus the number of flow paths is dependent on the number of cylinders, making a targeted, selected cooling of the individual cylinders and combustion chambers as a function of the current engine operating state feasible. An approximately uniform temperature distribution of the individual cylinders can be established in all operating states, with the effect of reducing wear to the corresponding engine components. Because as a result the temperature variance is only slight, the tendency to knocking in full-load operation, for instance, or nitrogen oxide emissions can be reduced.

Further advantageous refinements and features of the invention are obtained by the provisions recited in the dependent claims.

### DRAWING

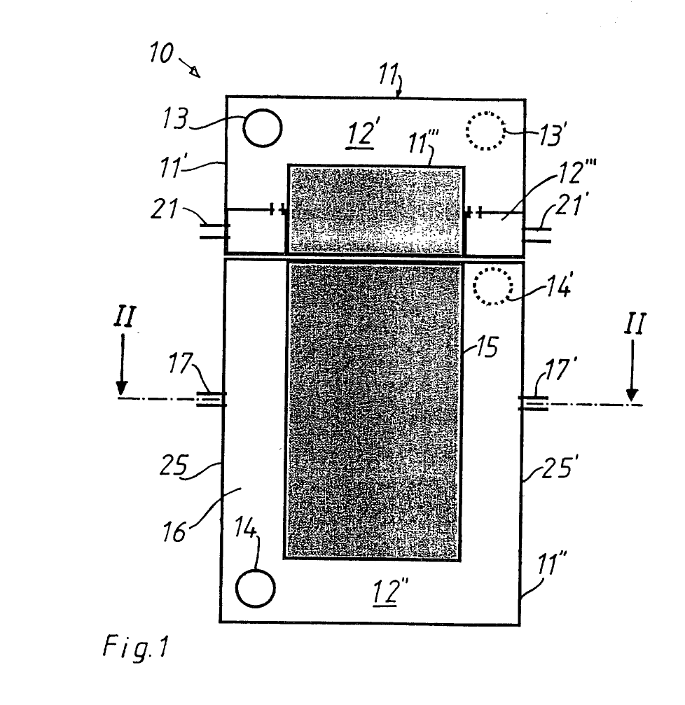

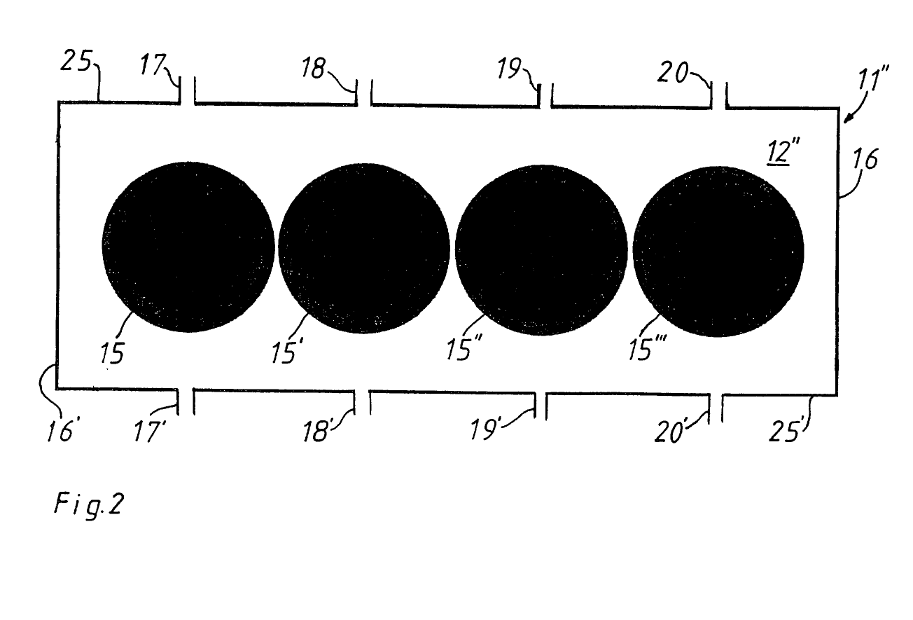

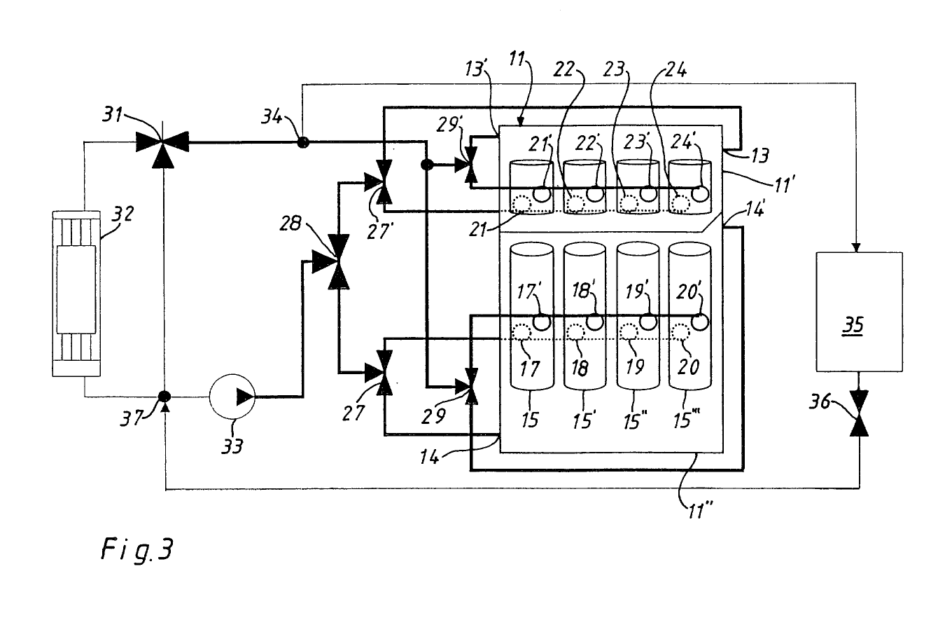

One exemplary embodiment of the invention is shown and described in the ensuing description and drawing. The drawing, in FIG. 1, shows a side view of an internal combustion engine, embodied in this exemplary embodiment as a 4-cylinder in-line engine, with coolant connections of the apparatus according to the invention for coupling to a cooling loop. FIG. 2 is a sectional view of a cylinder block of the engine with coolant connections, on the inflow and outflow sides, of the apparatus according to the invention in a plan view taken along the section line II-II of FIG. 1. FIG. 3 is a schematic elevation view of the apparatus according to the invention with the associated coolant loop for cooling the engine.

### DESCRIPTION OF THE EXEMPLARY EMBODIMENT

The apparatus for cooling, identified in its entirety in FIG. 1 by reference numeral 10, of an internal combustion engine 11 embodied in this exemplary embodiment as a 4-cylinder in-line engine has one cooling jacket region 12′, 12″, 12′″ each for the cylinder head 11′, cylinder block 11″ and combustion chamber 11′″ of the engine 11. The cooling jacket regions 12′, 12″ are disposed separately from one another and have inflow and outflow lines, associated in pairs with one another and intended for connection to a coolant loop, which in the exemplary embodiment are embodied as coolant connections 13, 13′, 14, 14′ and serve the purpose of coupling to the cooling loop on the inflow and outflow sides. To that end, on both the cylinder head 11′ and the cylinder block 11″, a respective pair of coolant connections 13, 13′, 14, 14′ is provided for the respective associated cooling jacket region 12, 12′; these coolant connections are disposed in the horizontal longitudinal direction or the longitudinal direction of the crankshaft of the engine 11, that is, in the direction defined by the in-line arrangement of individual cylinders 15, on opposed side walls 16, 16′ of the engine 11 in such a way that the respective flow direction of these coolant connections is oriented along the longitudinal direction of the crankshaft. In addition, in a direction also disposed horizontally and extending transversely to the longitudinal direction of the crankshaft, a further group of inflow and outflow lines 17-20, 17′-20′; 21-24, 21′-24′, in the exemplary embodiment embodied as coolant connections, is provided on both the cylinder block 11″ and the cylinder head 11′ on opposed side walls 25, 25′.

FIG. 2 illustrates the geometrical disposition of this second group of coolant connections 17-20 and 17′-20′ on the cylinder block 11″; each cylinder 15, 15, 15″, 15′″ is assigned two coolant connections 17, 17′, 18, 18′, 19, 19′, 20, 20′, which are diametrically opposed and mirror-symmetrical to one another with respect to the respective cylinder 15, 15, 15″, 15′″. Thus the individual pairs of coolant connections 17-20, 17′-20′; 21-24, 21′-24′ are spaced apart from one another in accordance with the spacing of the respective adjacent cylinders along the longitudinal direction of the crankshaft; the coolant connections 17-20 on the inflow side are disposed on the face-end side wall 25 of the cylinder block 11, and the coolant connections 17′-20′ on the outflow side are disposed on the opposite side wall 25′, in such a way that their respective flow direction points transversely to the longitudinal direction of the crankshaft and to the respective associated cylinder 15, 15, 15″, 15′″. As a result—unlike the longitudinally oriented coolant connections 13, 13′, 14, 14′, as a result of which the serially disposed cylinders 15, 15, 15″, 15′″ receive an oncoming flow in succession—the individual cylinders 15, 15, 15″, 15′″ can experience an oncoming flow directly and simultaneously because of the coolant flows that are parallel in the transverse direction. The cylinder head 11′ as well—which for reasons of symmetry is not shown separately—is analogously provided with the same geometrical arrangement of inflow and outflow lines 21-24 and 21-24′ embodied as coolant connections, so that on opposed side walls 25, 25′ of the cylinder head 11′, each cylinder 15, 15, 15″, 15′″ is assigned a respective pair of coolant connections 21, 21′, 22, 22′, 23, 23′, 24, 24′, whose flow direction points transversely to the longitudinal direction of the crankshaft and to the respective associated cylinder 15, 15, 15″, 15′″. This group of inflow and outflow lines 21-24, 21′-24′associated with the cylinder head 11′ supplies the cooling jacket region 12′″, intended for the combustion chamber 11′″ and divided up into cooling pockets, while by comparison the group of inflow and outflow lines 17-20, 17′20′ associated with the cylinder block 11″ opens into the cooling jacket region 12″ received in the cylinder block 11″. Because in addition the inflow and outflow lines 17-20, 17′-20′; 21-24, 21′-24′ each have suitable metering bores with flow directions extending transversely to the longitudinal direction of the crankshaft, a thermal cylinder synchronization for each operating point is attainable by means of a delivery of coolant to each cylinder 15, 15, 15″, 15′″ which can be adapted via the metering bores, and by the resultant regulatable longitudinal and transverse flow to the cylinders.

FIG. 3 shows the apparatus 10 according to the invention with the associated cooling loop. On the inflow side, the coolant connections 17-20 associated with the cylinder block 11″ and disposed transversely communicate with a first outlet of a mixing valve 27, while the second outlet of this valve communicates on the inflow side with the longitudinally disposed coolant connection 14, so that this mixing valve 27 serves to adjust the mixture ratio between the longitudinally disposed coolant connection 14 and the transversely disposed coolant connections 17-19. Analogously, on the inflow side the coolant connections 21-24 associated with the cylinder head 11′ and disposed transversely communicate with a first outlet of a further mixing valve 27′, while its second outlet communicates on the inflow side with the longitudinally disposed coolant connection 13, so that this second mixing valve 27′ serves to adjust the mixture ratio between the longitudinally disposed coolant connection 13 and the transversely disposed coolant connections 21-24. To adjust the coolant mixture ratio on the inflow side between the cylinder head 11′ and the cylinder block 11″, the inlet of the first mixing valve 27 communicates with a first outlet of a third mixing valve 28, and the inlet of the second mixing valve 27′ communicates with a second outlet of the third mixing valve 28.

On the outflow side, the transverse coolant connections 17′-20′ associated with the cylinder block 11″ communicate with a first inlet of a mixing valve 29, while its second inlet communicates on the outflow side with the longitudinally disposed coolant connection 14′. Analogously, on the outflow side, the transversely disposed coolant connections 21′-24′ associated with the cylinder head 11″ communicate with a first inlet of a further mixing valve 29′, while its second inlet communicates on the outflow side with the longitudinally disposed coolant connection 13′. The two mixing valves 29, 29′ are adjustable separately from one another and serve to return the coolant that has become heated in the engine 11; they each have an outlet, and the outlet of the mixing valve 29 communicates with the outlet of the mixing valve 29′; these two outlets communicate with an inlet of a thermostat valve 31, which on the outlet side feeds the heated coolant, flowing out of the cylinder head 11″ and the cylinder block 11′ via the mixing valves 29, 29′ into a radiator 32. The radiator 32 in turn delivers coolant at a reduced temperature to a feed pump 33, which communicates on the outlet side with one inlet of the mixing valve 28. Via a branching point 34, upstream of the inlet of the thermostat valve 31, a portion of the coolant flowing in from the return valves 29, 29′ is branched off and delivered to a heat exchanger 35, whose exit side communicates via a reducing valve 36 with a branching point 37 disposed between the radiator 32 and the feed pump 33, so that the coolant whose temperature is reduced in the heat exchanger 35 is delivered to the feed pump 33. A portion of the coolant delivered to the thermostat valve 31 is carried to the feed pump via a second outlet, coupled to the branching point 37, of the thermostat valve 31. The branches defined by the radiator 32 and the heat exchanger 35, respectively, of the coolant loop can thus be operated by a single feed pump 33.

Thus, for instance for the inflow and outflow lines shown in FIG. 2 for the cylinder block 11″, the following flow conditions are feasible: In a first version, the split streams delivered to the respective four transversely disposed inflow and outflow lines 17-20 and 17′-20′ of the cylinder block 11″ each amount to approximately 25% of the coolant flow delivered to the cylinder block 11″, while the split stream in the longitudinally disposed inflow line 14 of the cylinder block 11″ amounts to approximately 0% of the coolant flow delivered to the cylinder block, so that at the corresponding outflow line 14′, the corresponding split stream of approximately 0% flows out. In a second version, the split streams delivered to the transversely disposed inflow lines 17-20 of the cylinder block 11″ each amount to approximately 0% of the coolant flow delivered to the cylinder block 11″, and at the corresponding outflow lines 17′-20′, again approximately 0% is carried away, while the split stream in the longitudinally disposed inflow line 14 of the cylinder block 11″ amounts to approximately 100% of the coolant flow delivered to the cylinder block, so that at the corresponding outflow line 14′ the corresponding split stream amounts to 100%. In a third version, the split streams of the coolant flow delivered to the cylinder block 11″, specifically to the four transversely disposed inflow lines 17-20 of the cylinder block 11″, each amount to approximately 10%, and at the corresponding outflow lines 17′-20′, approximately 25% is carried away from each, while the split stream in the longitudinally disposed inflow line 14 of the cylinder block 11″is adjusted to approximately 60%, so that approximately 0% flows out at the outflow line 14′ corresponding to it. In a fourth version, the split streams of the coolant flow delivered to the cylinder block 11″, specifically to the four transversely disposed inflow lines 17-20 of the cylinder block 11″, each amount to approximately 0%, and at the corresponding outflow lines 17′-20′ approximately 25% is carried away from each, while the split stream in the longitudinally disposed inflow line 14 of the cylinder block 11″ is adjusted to approximately 100%, so that approximately 0% flows away from the outflow line 14′ corresponding to it.

It is accordingly characteristic for the invention that as coolant connections, a group of paired inflow lines 17-24 and outflow lines 17′-24′, each having flow directions, is provided, and each pair of inflow and outflow lines, because of their respective flow direction, defines a flow path, and each cylinder 15, 15, 15″, 15′″ is assigned a respective flow path flowing to the respective cylinder. The flow directions thereof extend transversely to the longitudinal direction of the crankshaft that is defined by the in-line arrangement of individual cylinders 15, 15, 15″, 15′″. A further group of inflow and outflow lines 13, 13′; 14, 14′ is disposed longitudinally to the longitudinal direction of the crankshaft. Because in addition the inflow and outflow lines disposed transversely to it each have metering bores, a thermal cylinder synchronization for each operating point is attainable by means of a delivery of coolant to each cylinder that is adapted by way of these metering bores.

In summary, the following advantages are attainable:

Because of the capability of establishing an approximately uniform temperature distribution in all operating states, the thermal load on the components belonging to the combustion chamber decreases and thus has the effect of reducing wear. Because of the selective delivery of coolant split streams to the individual combustion chamber regions and the precise cooling that is possible as a result, the volumetric flow required for a uniform temperature distribution drops, thus leading to a reduction in consumption. A drop in the flow resistance because of the embodiment of the coolant split streams parallel to one another in the transverse direction also has the effect of reducing consumption.

1. An apparatus for cooling an internal combustion engine, preferably a 4-cylinder in-line engine, having coolant connections to a cooling loop that are provided on the engine, the coolant connections discharging into at least one cooling jacket region of the engine, characterized in that as the coolant connections, a group of inflow lines (17-24) and outflow lines (17′-24′), paired with one another, is provided, and each pair of inflow and outflow lines, because of its respective flow direction, defines a flow path, and each cylinder (15, 15′, 15″, 15′″) is assigned at least one flow path supplying it.

2. The apparatus of claim 1, characterized in that the respective flow paths supplying the cylinders (15, 15′, 15″, 15′″) extend parallel to one another.

3. The apparatus of claim 1 or 2, characterized in that the inflow and outflow lines (17, 17′-24, 24′) paired with one another and each having flow directions are disposed such that the flow directions extend transversely to the longitudinal direction of the crankshaft defined by the in-line arrangement of the individual cylinders (15, 15′, 15″, 15′″).

4. The apparatus of claim 3, characterized in that the respective pairs of inflow and outflow lines (17, 17′-24, 24′) are spaced apart from one another in accordance with the spacing of the respective adjacent cylinders (15, 15, 15″, 15′″).

5. The apparatus of claims 3-4, characterized in that the respective pairs of inflow and outflow lines (17, 17′-24, 24′) are diametrically opposite one another and mirror-symmetrical with respect to the respective associated cylinder (15, 15, 15″, 15′″).

6. The apparatus of claim 5, characterized in that the respective pairs of inflow and outflow lines (17, 17′-24, 24′) are disposed on opposed side walls (25, 25′) of both a cylinder head (11′) enclosed by the engine (11) and a cylinder block (11″) enclosed by the engine (11).

7. The apparatus of claim 6, characterized in that the pairs of inflow and outflow lines (21, 24′-24, 24′) associated with the cylinder head (11′) are connected to a cooling jacket region (12′) received in the cylinder head (11′).

8. The apparatus of claim 7, characterized in that the inflow and outflow lines (21, 24′-24, 24′)) associated with the cylinder head (11′) feed a cooling jacket region, embodied as cooling pockets (12′″), intended for a combustion chamber (11′″) enclosed by the engine (11).

9. The apparatus of one of claims 6-8, characterized in that the pairs of inflow and outflow lines (17-20, 17′-20′) associated with the cylinder block (11″) are connected to a cooling jacket region (12″) received in the cylinder block (11″).

10. The apparatus of one of claims 1-9, characterized in that the inflow and outflow lines (17, 17′-24, 24′) have metering bores.

11. The apparatus of one of claims 1-10, characterized in that a further group of inflow and outflow lines (13, 13′; 14, 14′) is provided on opposed side walls (16, 16″) penetrated from the longitudinal direction of the crankshaft, and the flow directions of these side walls are oriented longitudinally of the longitudinal direction of the crankshaft.

12. The apparatus of claim 11, characterized in that the apparatus (10) has valve means (27, 27′, 28, 29, 29′, 31, 36), with which the inflow and outflow lines (13, 13′, 14, 14′; 17-20, 17′-20′; 21-24, 21′-24′) are triggerable in such a way that a greater proportion of the coolant flow delivered from the cooling loop (32, 33, 34, 35, 36, 37) flows via the group of inflow and outflow lines (17-20, 17′-20′; 21-24, 21′-24′) disposed transversely to the longitudinal direction of the crankshaft, and by comparison a smaller proportion of the coolant flow flows via the group of inflow and outflow lines (13, 13′; 14, 14′) disposed longitudinally of the longitudinal direction of the crankshaft.

13. The apparatus of claim 12, characterized in that the valve means have at least a first mixing valve (28) for splitting the coolant flow into split streams associated with the cylinder block (11″) and the cylinder head (11′), respectively.

14. The apparatus of claim 13, characterized in that the valve means have a first group of at least two mixing valves (27, 27′), disposed downstream of the first mixing valve (28), for adjusting a mixture of split streams of the coolant flow associated with the longitudinally disposed inflow and outflow lines (13, 14) on the one hand and with the transversely disposed inflow and outflow lines (17-20, 21-24) on the other.

15. The apparatus of one of claims 13 or 14, characterized in that the valve means have a second group of at least two further mixing valves (29, 29′) for returning coolant flowing out of the engine (11).

16. The apparatus of claim 14 or 15, characterized in that the mixing valves (27, 27′; 29, 29′) included in the respective group are each connected parallel to one another.

17. The apparatus of one of claims 13-16, characterized in that the valve means are embodied such that the mixing valves (27, 28) associated with the cylinder block (11″) can be turned off at least temporarily.

18. The apparatus of one of claims 12-17, characterized in that split streams of the coolant flow associated with the transversely disposed inflow and outflow lines (17, 17′-24, 24′) are each adjustable selectively relative to one another.

19. The apparatus of one of claims 12-18, characterized in that the valve means are switched such that the split streams in the transversely disposed inflow and outflow lines (17-20, 17′-20′) of the cylinder block (11″) each amount to approximately 0% of the coolant flow delivered to the cylinder block (11″), and in the longitudinally disposed inflow and outflow lines (14, 14′) of the cylinder block (11″) amount to approximately 100% of the coolant flow delivered to the cylinder block.

20. The apparatus of one of claims 12-18, characterized in that the valve means are switched such that the split streams in the transversely disposed inflow and outflow lines (17-20, 17′-20′) of the cylinder block (11″) each amount to approximately 25% of the coolant flow delivered to the cylinder block (11″), and in the longitudinally disposed inflow and outflow lines (14, 14′) of the cylinder block (11″) amount to approximately 0% of the coolant flow delivered to the cylinder block.

21. The apparatus of claim 18, characterized in that the valve means are switched such that the split streams in the transversely disposed inflow and outflow lines (17-20, 17′-20′) of the cylinder block (11″) each amount to approximately 10% in the inflow lines and approximately 25% in outflow lines (17′-20′) of the coolant flow delivered to the cylinder block (11″), while by comparison in the longitudinally disposed inflow and outflow lines (14, 14′) of the cylinder block (11″) they amount to approximately 60% in the inflow line (14) and approximately 0% in the outflow line (14′) of the coolant flow delivered to the cylinder block.

22. The apparatus of claim 18, characterized in that the valve means are switched such that the split streams in the transversely disposed inflow and outflow lines (17-20, 17′-20′) of the cylinder block (11″) each amount to approximately 0% in the inflow lines and approximately 25% in outflow lines (17′-20′) of the coolant flow delivered to the cylinder block (11″), while by comparison in the longitudinally disposed inflow and outflow lines (14, 14′) of the cylinder block (11″) they amount to approximately 100% in the inflow line (14) and approximately 0% in the outflow line (14′) of the coolant flow delivered to the cylinder block.
